(19) United States
(12) Patent Application Publication
(10) Pub. No.: US 2011/0304915 A1
(43) Pub. Date: Dec. 15, 2011

(54) DIFFRACTIVE OPTICAL ELEMENT, OPTICAL SYSTEM, AND OPTICAL APPARATUS

(75) Inventor: Reona USHIGOME, Utsunomiya-shi (JP)

(73) Assignee: CANON KABUSHIKI KAISHA, Tokyo (JP)

(21) Appl. No.: 13/157,628

(22) Filed: Jun. 10, 2011

(30) Foreign Application Priority Data
Jun. 11, 2010 (JP) 2010-134018

(51) Int. Cl. G02B 27/44

(52) U.S. Cl. 359/576

(57) ABSTRACT

A diffractive optical element includes a first diffraction grating and a second diffraction grating, and a thin film which is arranged at least part of an interface between the first diffraction grating and the second diffraction grating, includes a single layer or multiple layers made of a material different from that of each of the first and second diffraction gratings, and is transparent to light of a working wavelength range. nd1<nd2, 0.15<nd2-nd3<0.80, and 1/{100×(nd2-nd3)}μm<w<0.05×P μm are satisfied, where nd1 is a refractive index of the material of the first diffraction grating to d-line, nd2 is a refractive index of the material of the second diffraction grating to the d-line, nd3 is a minimum refractive index of the material of one layer of the thin film to the d-line, w is a total thickness, and P is a grating pitch.

### BACKGROUND OF THE INVENTION

1. Field of the Invention

The present invention relates to a diffractive optical element used for a lens in an optical system, the optical system, and an optical apparatus having the optical system.

2. Description of the Related Art

For a diffractive optical element used for a lens in an optical system, it is known to adhere two diffraction gratings closely to each other and to properly set a material and a grating height of each diffraction grating so as to provide high diffraction efficiency over a wide wavelength range. When a light flux enters this diffracting optical element that has a Blazed structure and includes grating surfaces and grating wall surfaces, the incident light flux is reflected on or diffracted by the grating wall surface, causing unnecessary light (flare). Japanese Patent Laid-Open Nos. (“JPs”) 2003-240931 and 2004-126394 propose a diffractive optical element that includes an absorption film on the grating wall surface so as to restrain the unnecessary light (flare) on the grating wall surface. JPs 2004-13081 and 2005-62717 adhere two diffraction gratings closely to each other and provide a thin film so as to improve the adhesion property on the interface. JP 2009-217139 discloses a calculation of diffraction efficiency utilizing the rigorous coupled wave analysis (“RCWA”).

For the diffractive optical element used for the lens in the optical system, especially problematic and unnecessary light is unnecessary light caused by a total reflection on an interference between a high refractive index medium and a low refractive index medium, of a light flux incident at an obliquely incident angle (off-screen light incident angle) different from a designed incident light flux. However, JPs 2003-240931, 2004-126394, 2004-13081, and 2005-62717 do not care about this problem, or provides an insufficient effect of restraining the unnecessary light.

### SUMMARY OF THE INVENTION

Accordingly, the present invention provides a diffractive optical element, an optical system, and an optical apparatus, which can restrain unnecessary light.

A diffractive optical element according to the present invention includes a first diffraction grating and a second diffraction grating which are made of materials different from each other and are stacked in an optical axis direction, and a thin film which is arranged at least part of an interface between the first diffraction grating and the second diffraction grating, includes a single layer or multiple layers made of a material different from that of each of the first and second diffraction gratings, and is transparent to light of a working wavelength range. nd1<nd2, 0.15<nd2-nd3<0.80, and 1/{100×(nd2-nd3)}<w<0.05×P are satisfied, where nd1 is a refractive index of the material of the first diffraction grating to d-line, nd2 is a refractive index of the material of the second diffraction grating to the d-line, nd3 is a minimum refractive index of the material of one layer of the thin film to the d-line, w is a total thickness, and P is a grating pitch.

Further features of the present invention will become apparent from the following description of exemplary embodiments with reference to the attached drawings.

### BRIEF DESCRIPTION OF THE DRAWINGS

FIG. 1 illustrates a plane view and a side view of a diffractive optical element according to a first embodiment.

FIG. 2 is a partially enlarged sectional view of FIG. 1 according to the first embodiment.

FIG. 3 is a partially enlarged perspective view of the diffraction grating unit illustrated in FIG. 1 according to the first embodiment.

FIG. 4 is a partially enlarged sectional view of FIG. 2 according to the first embodiment.

FIG. 5 illustrates an optical path of an optical system having the diffractive optical element illustrated in FIG. 1 according to the first embodiment.

FIG. 6 is a schematic view for explaining influence of unnecessary light in the optical system illustrated in FIG. 5 according to the first embodiment.

FIGS. 7A and 7B are graphs of the diffraction efficiency of the diffractive optical element illustrated in FIG. 5 to an off-screen light flux having an incident angle of +10° according to the first embodiment.

FIGS. 8A and 8B are graphs of a comparative example 1 to FIG. 7.

FIGS. 9A and 9B are graphs of diffraction efficiency of the diffractive optical element to a designed incident light flux according to the first embodiment.

FIGS. 10A and 10B are graphs of diffraction efficiency of the diffractive optical element to the designed incident light flux according to the comparative example 1.

FIGS. 11A and 11B are graphs of diffraction efficiency of the diffractive optical element to an off-screen light flux having an incident angle of −10° according to the first embodiment.

FIGS. 12A and 12B are graphs of diffraction efficiency of the diffractive optical element to an off-screen light flux having an incident angle of −10° according to the comparative example 1.

FIG. 13 is a schematic view for explaining a problem of the comparative example 1 illustrated in FIG. 8.

FIG. 14 is a graph of diffraction efficiency of a diffractive optical element to an off-screen light flux having an incident angle of +10° according to a second embodiment.

FIG. 15 is a graph of diffraction efficiency of the diffractive optical element to a designed incident light flux according to the second embodiment.

FIG. 16 is a graph of diffraction efficiency of the diffractive optical element to an off-screen light flux having an incident angle of −10° according to the second embodiment.

FIG. 17 is a graph of diffraction efficiency of a diffractive optical element to an off-screen light flux having an incident angle of +10° according to a third embodiment.

FIG. 18 is a graph of diffraction efficiency of the diffractive optical element to a designed incident light flux according to the third embodiment.

FIG. 19 is a graph of diffraction efficiency of the diffractive optical element to an off-screen light flux having an incident angle of −10° according to the third embodiment.

FIG. 20 is a graph of diffraction efficiency of a diffractive optical element to an off-screen light flux having an incident angle of +10° according to a comparative example 2.

FIG. 21 is a graph of diffraction efficiency of a diffractive optical element to an off-screen light flux having an incident angle of +10° according to a comparative example 3.

FIG. 22 is a partially enlarged sectional view of a diffractive optical element according to a fourth embodiment.

FIG. 23 is a partially enlarged sectional view of a diffractive optical element according to a fifth embodiment.

FIG. 24 is a graph of diffraction efficiency of the diffractive optical element illustrated in FIG. 23 to an off-screen light flux having an incident angle of +10° according to the fifth embodiment.

FIG. 25 is a graph of diffraction efficiency of the diffractive optical element to a designed incident light flux according to the fifth embodiment.

FIG. 26 is a graph of diffraction efficiency of the diffractive optical element to an off-screen light flux having an incident angle of −10° according to the fifth embodiment.

FIG. 27 is a partially enlarged sectional view of a diffractive optical element according to a sixth embodiment.

FIG. 28 is a graph of diffraction efficiency of the diffractive optical element illustrated in FIG. 27 to an off-screen light flux having an incident angle of +10° according to the sixth embodiment.

FIG. 29 is a graph of diffraction efficiency of the diffractive optical element to a designed incident light flux according to the sixth embodiment.

FIG. 30 is a graph of diffraction efficiency of the diffractive optical element to an off-screen light flux having an incident angle of −10° according to the sixth embodiment.

### DESCRIPTION OF THE EMBODIMENTS

A description will be given of embodiments of the present invention with reference to the accompanying drawings:

### First Embodiment

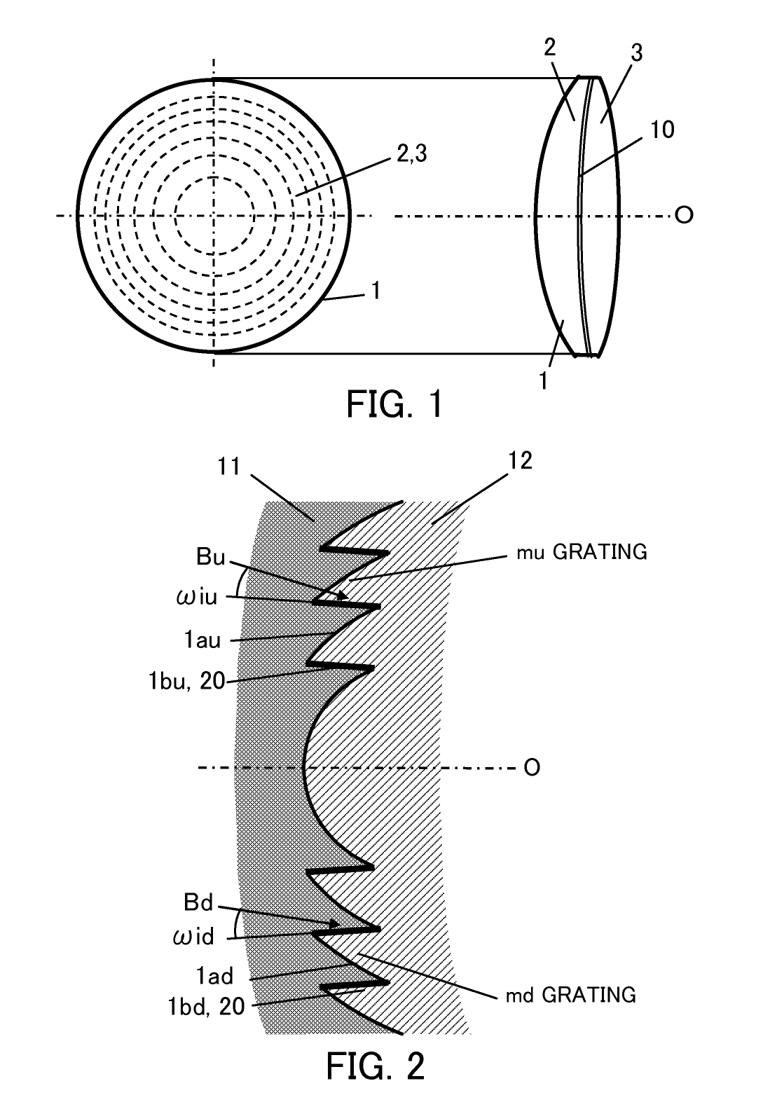

FIG. 1 illustrates a plane view and a side view of a diffractive optical element (“DOE”) 1 according to a first embodiment. The DOE 1 is configured to improve diffraction efficiency of diffracted light of one specific or designed order in a working wavelength range in an overall visible wavelength range.

The DOE 1 includes a pair of transparent substrates 2 and 3, and a diffraction grating unit 10 arranged between them. While each of the substrates 2 and 3 may have a flat plate shape or a lens serving shape, each of top and bottom surfaces of the substrate 2 and top and bottom surfaces of the substrate 3 has a curved surface in this embodiment.

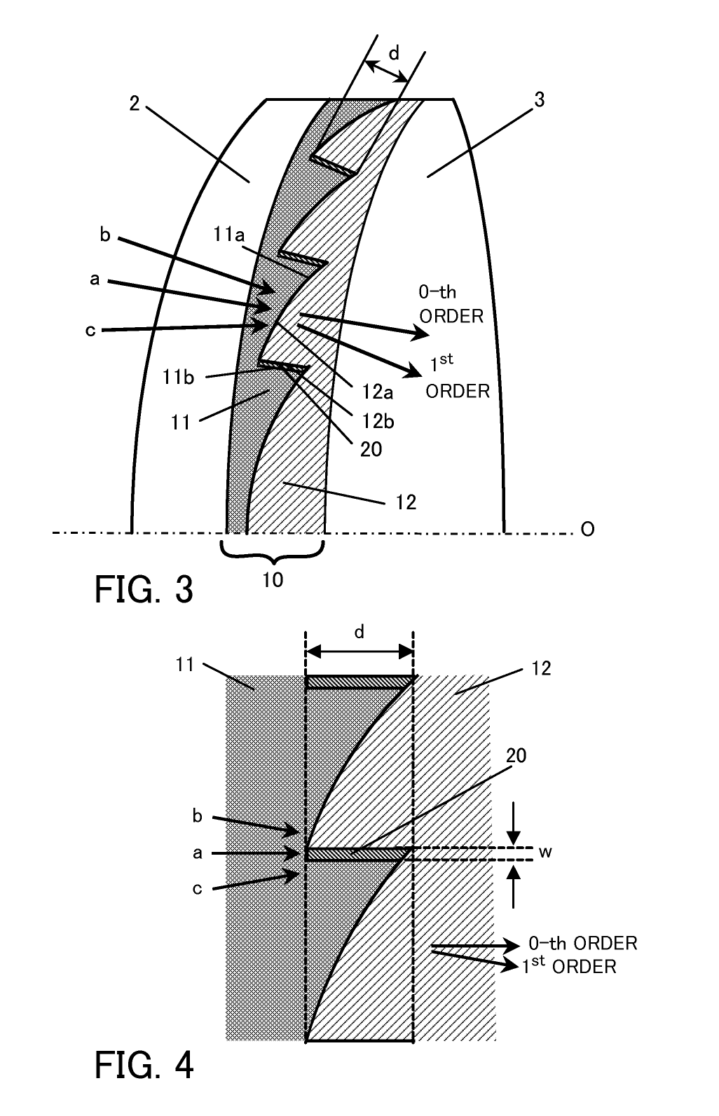

The diffraction grating unit 10 has a concentric diffraction grating shape with the optical axis O as a center, and provides a lens operation. FIG. 2 is a partially enlarged sectional view near the center part of FIG. 1. FIG. 3 is a partially enlarged perspective view of the diffraction grating unit 10. FIG. 4 is an enlarged sectional view of FIG. 2.

For better understanding of the grating shape, FIGS. 2 to 4 are exaggeratedly deformed in the grating depth direction, and the number of gratings in these figures is depicted less than the actual number. In FIGS. 3 and 4, an incident light flux “a” is a light flux incident at an incident angle of 0° as a designed incident angle of the DOE 1. An incident light flux “b” is a downwardly incident light flux incident at an obliquely (off-screen) incident angle. An incident light flux “c” is an upwardly incident light flux incident at an oblique (off-screen) incident angle.

In FIGS. 1 and 3, the diffraction grating unit 10 includes a (first) diffraction grating 11 and a (second) diffraction grating 12 that are adhered closely to each other in the optical axis direction, and a thin film 20 that is provided on each grating wall surface between the diffraction gratings 11 and 12 and transparent in the working wavelength range. The diffraction grating 11 and the substrate 2 may be integrated or separate members. The diffraction grating 12 and the substrate 3 may be integrated or separate members.

While the diffraction gratings 11 and 12 are adhered closely to each other in the optical axis direction in this embodiment, the lying thin film 20 may be provided throughout the interface between the diffraction gratings 11 and 12, as discussed later. Therefore, it is sufficient that the diffraction gratings 11 and 12 are stacked in the optical axis directions. There is no gap between the diffraction gratings 11 and 12 in this embodiment, but there may be a gap as described later.

The diffraction grating 11 has a concentric Blazed structure including grating surfaces 11a and grating wall surfaces 11b. The diffraction grating 12 has a concentric Blazed structure including grating surfaces 12a and grating wall surfaces 12b. Each of the diffraction gratings 11 and 12 gradually changes a grating pitch as a position moves from the optical axis O to the outer circumference, thereby realizing a lens serving operation (light converging effect and diverging effect).

The grating surface 11a contacts the grating surface 12a with no spaces, and the grating wall surface 11b contacts the grating wall surface 12b with no spaces. The diffraction gratings 11 and 12 serve as one diffraction grating unit 10 as a whole. The Blazed structure enables the incident light upon the DOE 1 to be diffracted in a specific diffracted order (+1^{st} order in FIGS. 3 and 4) direction to the 0^{th} order diffracted direction that transmits the diffraction grating unit 10 without diffractions.

Since the working wavelength range of the DOE 1 of this embodiment is a visible range, materials and grating heights of the diffraction gratings 11 and 12 are selected so as to provide high diffraction efficiency of the diffracted light of the designed order in the overall visible range. In other words, a material and grating height of each diffraction grating is determined so that a maximum optical path length difference (which is a maximum value of the optical path length difference between a crest and a trough of the diffraction unit) of the light that passes a plurality of diffraction gratings, i.e., the diffraction gratings 11 and 12, can be approximately integer times as large as the wavelength in the working wavelength range. High diffraction efficiency can be obtained in the overall working wavelength range by properly setting the material and shape of the diffraction grating.

In general, the grating height of the diffraction grating is defined as a height between a grating tip and the grating groove in a (grating normal) direction perpendicular to the grating periodic direction. When the grating wall inclines to the grating normal direction or when the grating tip is deformed, etc., it is obtained from an intersection between an extension line of the grating surface and the grating normal. The diffraction grating's material and grating height are not limited.

The diffraction grating 11 is made of fluorine acrylic ultraviolet (“UV”) curing resin mixed with ITO nanoparticles (nd=1.504, νd=16.3, θgF=0.390, and n550=1.511). The diffraction grating 12 is made of acrylic UV curing resin mixed with ZrO₂ nanoparticles (nd=1.567, νd=47.0, θgF=0.569, and n550=1.570). In each of the diffraction gratings 11 and 12, “nd” is a refractive index to the d-line, “νd” is an Abbe number to the d-line, “θgF” is a partial dispersion ratio between the g-line and the F-line, and n550 is a refractive index to a wavelength of 550 nm.

In this embodiment, the diffraction gratings 11 and 12 are made materials different from each other, and the diffraction grating 11 is made of a low refractive index dispersion material, and the diffraction grating 12 is made of a high refractive index dispersion material having a higher refractive index. However, it is sufficient that one of the refractive index of the material of the diffraction grating 11 to the d-line and the refractive index of the material of the diffraction grating 12 to the d-line is higher.

The resin material in which nanoparticles are dispersed is a UV curing material, and may contain, but is not particularly limited to, acrylic, fluoric, vinyl, or epoxy organic resin. This embodiment sets the designed order to +1^{st} order but the designed order is not limited to +1^{st} order and another designed order can provide a similar effect.

The nanoparticle may contain, but is not limited to, oxide, metal, ceramics, composite, or a mixture thereof. An average particle diameter of the nanoparticle material may be quarter as large as the (working or designed) wavelength of the incident light upon the DOE. A particle diameter larger than this value may increase Rayleigh scattering when the nanoparticle material is mixed with the resin material.

Instead of the resin material in which the nanoparticles are dispersed, an organic material, such as a resin material, a glass material, an optical crystalline material, and a ceramics material may be used.

Control over each annulus may be provided for each annulus of the DOE by changing a width or shape of the thin film. As a result, unnecessary light that would otherwise reach the imaging plane can be effectively restrained.

The thin film 20 has an approximately uniform thickness along the grating wall surface, is transparent to the light in the working wavelength range of the DOE, and is configured to reduce unnecessary light that is generated by the oblique (off-screen) incident light flux and would otherwise reach the imaging plane. The thin film 20 includes a single layer or multiple layers, but the thin film 20 in this embodiment includes a single layer.

The thin film 20 is provided onto at least part of the interference between the diffraction gratings 11 and 12, and onto the grating wall surfaces lbu, lbd in this embodiment. In FIG. 4, each of the grating wall surfaces lbu, lbd has a grating height d of 9.29 μm, and the designed order is +1^{st} order.

The thin film 20 is made of a material different from and higher than the material of each of the diffraction gratings 11 and 12, and is made of MgF₃ (a refractive index “n” of 1.38 to the d-line) in this embodiment. The thin film 20 has a thickness or width w of 0.2 μm in the direction perpendicular to the grating wall surface as a stacked surface.

A manufacturing method of the thin film 20 is not particularly limited. For example, the diffraction grating 12 is manufactured, and then the thin film 20 is selectively formed. More specifically, a thin film shape is formed using a material of the thin film and the vacuum evaporation, etc., and patterned through the lithography method or nano-imprinting, followed by the selective etching, etc. Alternatively, a forming method can use a mask pattern and a selective evaporation method. Thereafter, the DOE can be manufactured by forming the diffraction grating 11. The thin film 20 can be manufactured by the process, such as evaporation, less expensively and more easily than the absorption film manufacturing method disclosed in JP 2003-240931 and 2004-126394.

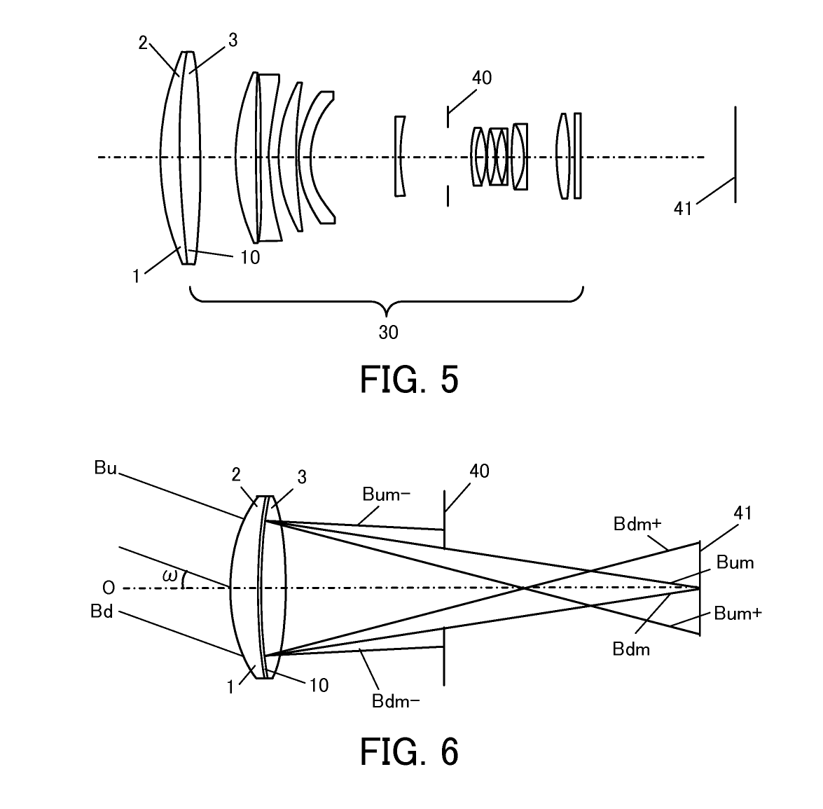

FIG. 5 illustrates a telephoto type of image pickup optical system using the DOE 1 and applicable to an image pickup apparatus, such as a camera, where f=392.00 mm, fno=4.12, a half field angle is 3.16, and a diffracting surface is provided on the second surface. FIG. 6 is a schematic view illustrating unnecessary light of the optical system illustrated in FIG. 5.

In FIG. 5, reference numeral 30 denotes an image pickup lens including a stop 40 and the DOE 1. The stop 40 is arranged at the rear side of the DOE 1. Reference numeral 41 denotes an imaging plane on which a film or photoelectric conversion element, such as a CCD and a CMOS, is arranged. A center of gravity (similar to a center of gravity of a diagram) of distributed incident angles of light fluxes incident upon the diffraction grating unit 10 is set so that it can distribute closer to the center of the diffraction grating unit 10 than the grating normal at the center of the diffraction grating of the envelope surface. The diffraction grating unit 10 is provided on, but not limited to, the adhesion surface in the front lens in FIG. 5, and may be provided on a lens surface or a plurality of diffraction grating units 10 may be used in the image pickup lens.

The optical system to which the DOE 1 is applicable is not limited to the image pickup optical system illustrated in FIG. 5, and may be an image pickup lens of a video camera, an imaging optical system used in a wide wavelength range for an imaging scanner and a reader lens in a copier, an observation optical system for a binocular or a telescope, or an optical viewfinder. An apparatus to which the optical system including the DOE 1 is applicable is not limited to the image pickup apparatus, and may be widely applicable to an optical apparatus.

In FIGS. 2 and 6, off-screen light fluxes Bu and Bd incident at an incident angle of ω to the optical axis O pass the substrate 2 enter the mu grating and the md grating which are the m-th diffraction gratings from the optical axis O in the upper direction and the lower direction. The incident angle upon the mu grating of the off-screen light flux Bu is iu to the principal ray direction and the incident angle upon the md grating of the off-screen light flux Bd is id to the principal ray direction. The grating wall surfaces lbu and lbd are parallel to the principal ray direction.

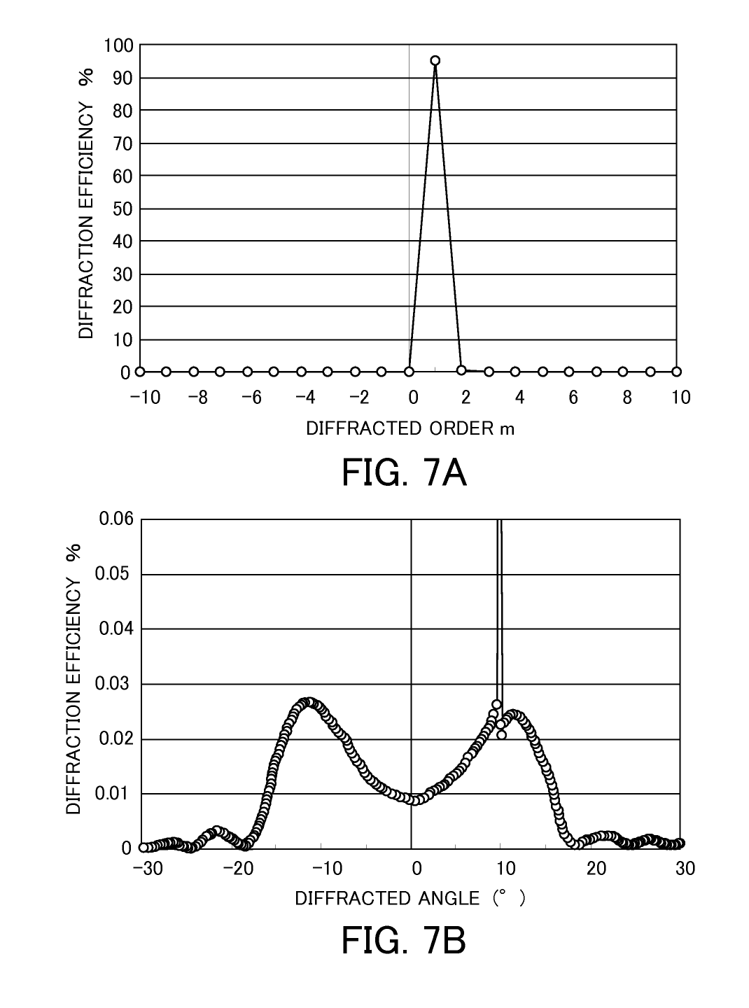

FIGS. 7A and 7B are graphs of RCWA calculation results with an incident angle of +10°, a grating pitch of 100 μm, and a wavelength of 550 nm by supposing the incident light “b” illustrated in FIG. 4 and the incident light “Bu” illustrated in FIG. 6. The incident angle is set positive in the downward direction in FIG. 4.

FIG. 7A illustrates diffraction efficiency near the +1st order diffracted light as the designed order, where the abscissa axis denotes a diffracted order and the ordinate axis denotes diffraction efficiency. FIG. 7B illustrates a high diffracted angle range by enlarging part of low diffraction efficiency of the ordinate axis of FIG. 7A and by converting the diffracted order of the abscissa axis into a diffracted angle. The diffracted angle is set positive in the downward direction in FIG. 4.

As illustrated in FIG. 7A, the +1^{st} order diffracted light as the designed order provides the highest diffraction efficiency, but this +1^{st} order diffracted light never reaches the image plane and its influence is small. It is understood that the remaining unnecessary light becomes unnecessary light having a peak in the specific angle direction and propagates as illustrated in FIG. 7B.

This unnecessary light has a peak in the approximately −10° direction, and the propagation direction is approximately equal to the exit direction of −10° direction in which an off-screen light flux component having an incident angle of +10° is totally reflected and propagated.

### COMPARATIVE EXAMPLE 1

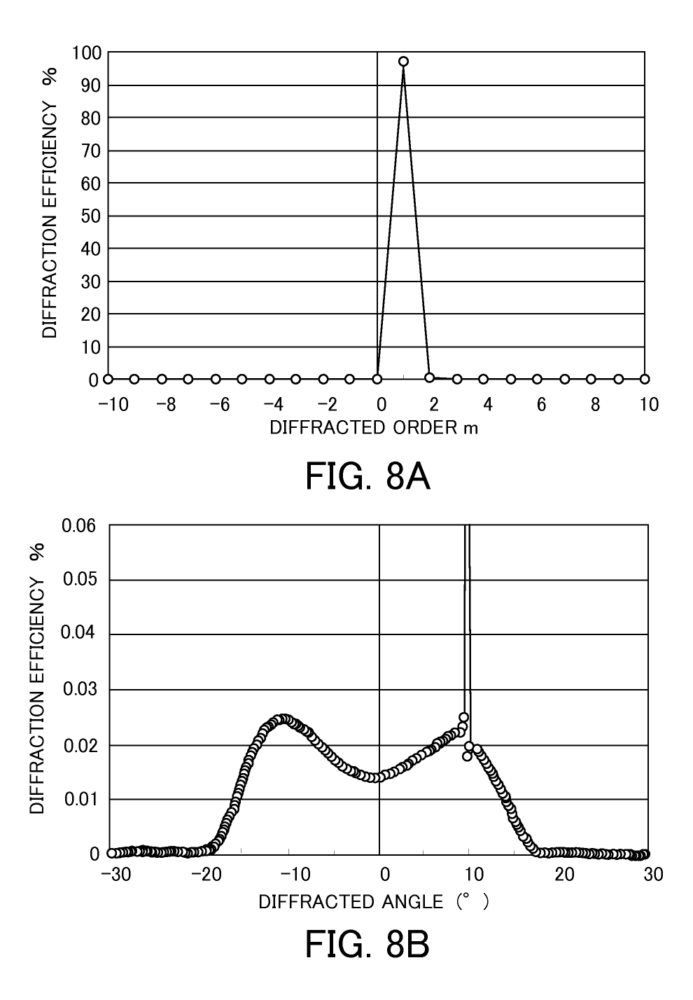

FIGS. 8A and 8B are graphs of a comparative example 1 corresponding to FIGS. 7A and 7B when the DOE of the comparative example 1 is structurally similar to FIG. 1 but does not have the thin film 20.

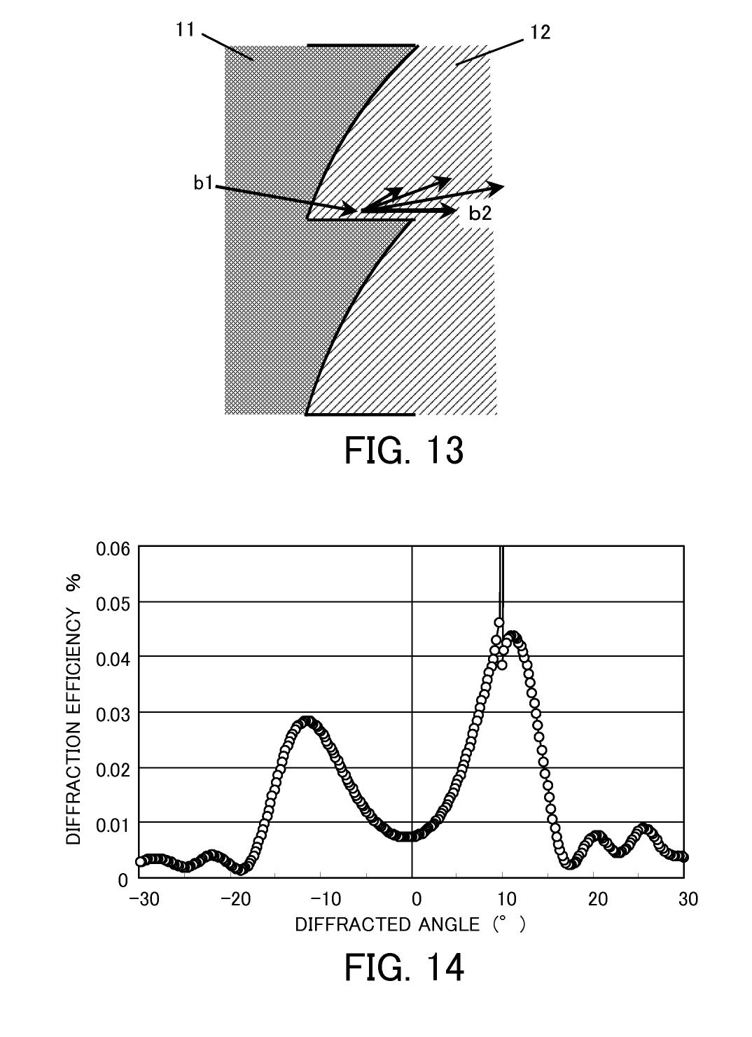

In this comparative example 1, as illustrated in light fluxes “b2” illustrated in FIG. 13, a light flux “b1” incident at an incident angle of +80°, which is larger than a critical angle of 74.2° from the high refractive index material side to the low refractive index material side, upon the grating wall surface is totally reflected on the grating wall surface and unnecessary light spreads from about −10° direction to a high angle range (near the diffracted angle of 0°). Since the diffracted angle of 0° is approximately equal to the diffracted angle of 0.20° (+1^{st} order diffracted light in FIG. 3) of the +1^{st} order diffracted light due to the designed incident angle of 0°, unnecessary light that exits at an angle near the diffracted angle of +0.20° among the unnecessary light derived from the off-screen light having an incident angle of +10° reaches the image plane.

The diffracted order and the diffracted angle of the unnecessary light that is derived from the off-screen incident light and reaches the image plane are different according to an optical system subsequent to the DOE. However, for any optical systems, at least diffracted light of unnecessary light derived from off-screen light reaches the image plane, when the diffracted light has a diffracted angle approximately equal to a diffracted angle at which a designed diffracted order having a designed incident angle is propagated, thereby causing the imaging performance to deteriorate.

A peak angle of unnecessary light in a −10° direction illustrated in FIG. 7B is approximately the same as that of FIG. 8B, but a spread of the unnecessary light is different between FIGS. 7B and 8B and FIG. 7B illustrates lower diffraction efficiency at a low diffracted angle.

In other words, according to this embodiment, a quantity of unnecessary light (such as light fluxes “b2” in FIG. 13) of the low refracted angle is reduced. In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order having the designed incident angle is propagated. From the RCWA calculation result, the diffraction efficiency near the diffracted angle of +0.20° in FIGS. 7A and 7B is 0.0092% for the diffracted order of a −46^{th} order (diffracted angle of +0.34°), and 0.0092% for the diffracted order of a −47^{th} order (diffracted angle of) +0.14°).

On the other hand, since the diffraction efficiency of the diffracted order of the comparative example 1 that has no thin film is 0.014% for the diffracted order of a −46^{th} order (diffracted angle of) +0.34°), and 0.014% for the diffracted order of a −47^{th} order (diffracted angle of +0.14°). This embodiment thus remarkably reduces the influence of the unnecessary light.

Next follows the influence of the incident light fluxes “a” and “”c″ illustrated in FIG. 4.

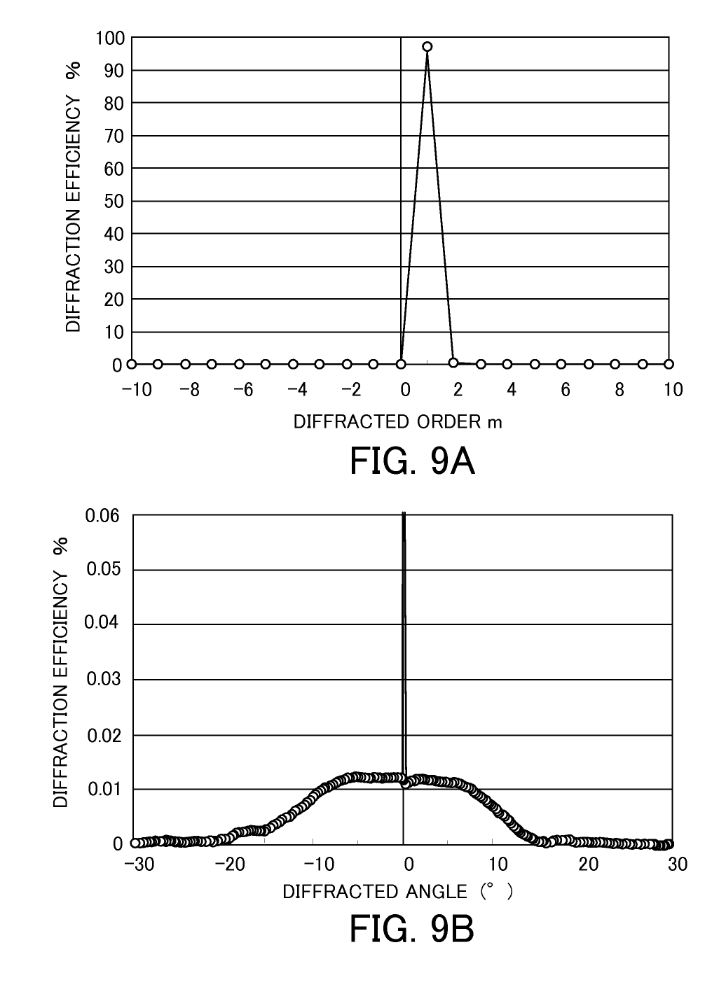

FIGS. 9A and 9B are graphs of RCWA calculation results with an incident angle of 0°, a grating pitch of 100 μm, and a wavelength of 550 nm by supposing the incident light flux “a” illustrated in FIG. 4.

FIG. 9A illustrates diffraction efficiency near the +1st order diffracted light as the designed order, where the abscissa axis denotes a diffracted order and the ordinate axis denotes diffraction efficiency. FIG. 9B illustrates a high diffracted angle range by enlarging part of low diffraction efficiency of the ordinate axis of FIG. 9A, and by converting the diffracted order of the abscissa axis into a diffracted angle. The diffracted angle is set positive in the downward direction in FIG. 4.

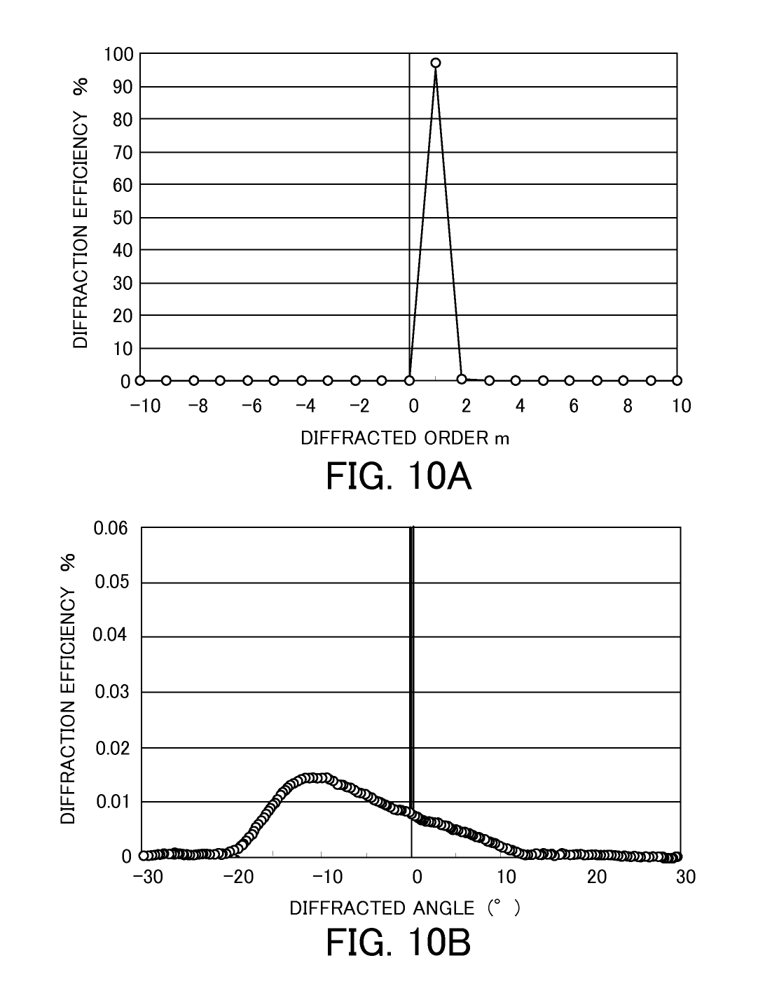

FIGS. 10A and 10B are graphs of the comparative example 1 corresponding to FIGS. 9A and 9B when the DOE is structurally similar to FIG. 1 but does not have the thin film 20.

According to FIG. 9A, the diffraction efficiency of the +1^{st} order diffracted light as the designed order is 98.49% (diffracted angle of +0.20°), as equivalent as or lower than the diffraction efficiency of 98.76% (diffracted angle of +0.20°) of the +1^{st} order diffracted light in the diffraction grating having no thin film as illustrated in FIG. 10A. It is understood that the remaining light becomes unnecessary light and propagates as illustrated in FIG. 9B. As a result of that the low refractive index thin film causes a phase shift, the diffraction efficiency of a comparatively low order (about +35^{th} orders at diffracted angles ±10°) increases and the diffraction efficiency of the +1^{st} order diffracted light as the designed order decreases. However, the supposed grating pitch is 100 μm as one reference. The grating pitch becomes larger as an annulus becomes closer to the optical axis as illustrated in FIG. 1 and the negative influence by the grating wall surface and the reflector decrease. Thus, the diffraction efficiency of the designed order improves and the diffraction efficiency of the unnecessary light becomes lower.

As a result, when the overall DOE region is considered, a difference of the diffraction efficiency of 0.27% with the grating pitch of 100 μm is seldom influential or problematic because it is rare to directly capture a high brightness light source, such as the sun, in daylight at the designed incident angle (the incident angle of the image pickup light). The influence of the unnecessary light is also small.

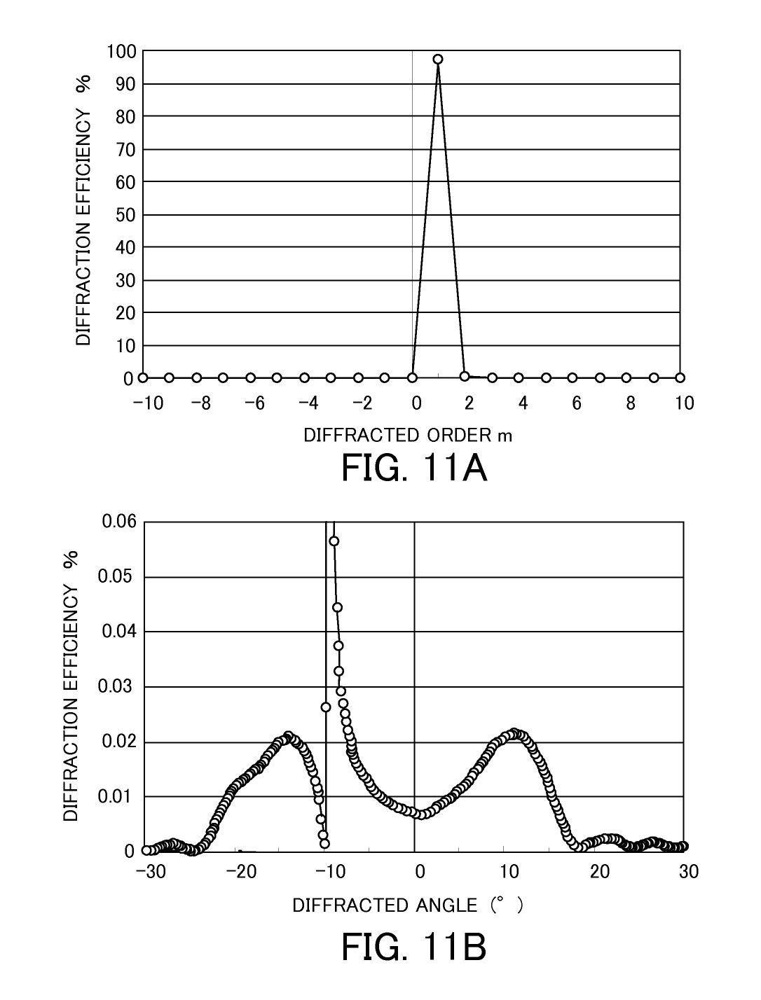

FIGS. 11A and 11B are graphs of RCWA calculation results with an incident angle of −10°, a grating pitch of 100 μm, and a wavelength of 550 nm by supposing the incident light flux “c” illustrated in FIG. 4. The incident angle is set positive in the downward direction in FIG. 4 (or the upper direction of and grating is positive in FIG. 2).

FIG. 11A illustrates diffraction efficiency near the +1^{st} order diffracted light as the designed order, where the abscissa axis denotes a diffracted order and the ordinate axis denotes diffraction efficiency. FIG. 11B illustrates a high diffracted angle range by enlarging part of low diffraction efficiency of the ordinate axis of FIG. 11A and by converting the diffracted order into a diffracted angle of the abscissa axis.

As illustrated in FIG. 11A, the +1^{st} order diffracted light as the designed order provides the highest diffraction efficiency, but this +1^{st} order diffracted light never reaches the image plane and its influence is small. It is understood that the remaining unnecessary light becomes unnecessary light having a peak in the specific angle direction and propagates as illustrated in FIG. 11B. This unnecessary light has a peak in an approximately −10° direction. A propagation direction of the peak of the approximately −10° direction is approximately equal to an exit direction of +10° of the reflected light that is made as a result of that an off-screen light flux having an incident angle of −10° upon the grating wall surface is reflected on the low refractive index thin film.

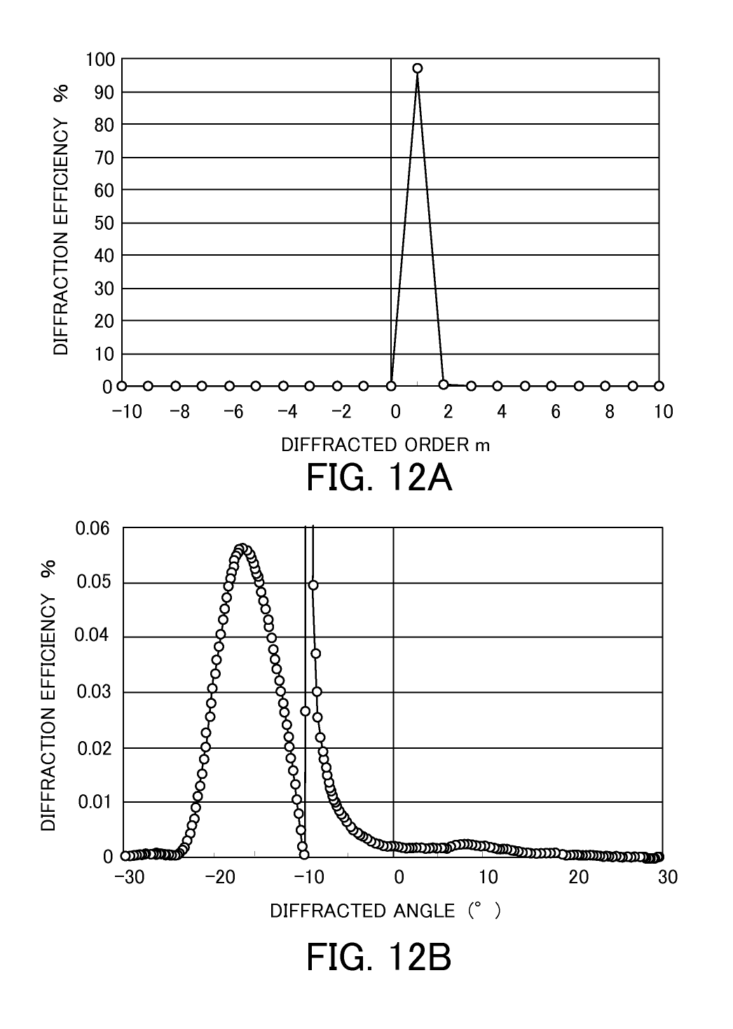

FIGS. 12A and 12B are graphs of the comparative example 1 corresponding to FIGS. 11A and 11B when the DOE of the comparative example is structurally similar to FIG. 1 but does not have the thin film 20. A peak of the unnecessary light illustrated in FIG. 12B corresponds to −16.6°, and exits in a reverse direction to the peak of +10° of the unnecessary light illustrated in FIG. 11B. When FIG. 11B is compared with FIG. 12B, a peak of the unnecessary light in the + direction increases and a peak of the unnecessary light in the − direction decreases. This means that the unnecessary light in the plus direction increases because part of the light flux incident upon the grating wall surface from the low refractive index medium side is reflected due to the low refractive index thin film provided on the grating wall surface, and the unnecessary light in the minus direction decreases due to transmissions.

In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order having the designed incident angle is propagated. From the RCWA calculation result, the diffraction efficiency near the diffracted angle of +0.20° in FIGS. 11A and 11B is 0.0072% for the diffracted order of a +49^{th} order (diffracted angle of +0.26°), and 0.0072% for the diffracted order of a +48^{th} order (diffracted angle of) +0.06°. On the other hand, the diffraction efficiency of the diffracted order of a +49^{th} order (diffracted angle of +0.26°) is 0.0021% and the diffraction efficiency of the diffracted order of a +48^{th} order (diffracted angle of +0.06°) is 0.0022% in the comparative example 1 as illustrated in FIGS. 12A and 12B. Although this embodiment has higher diffraction efficiencies than those of the comparative example, the values of the diffraction efficiency are extremely small and thus less influential on the deterioration of the imaging performance.

Thus, this embodiment provides a low refractive index thin film onto the grating wall surface in the optical system to which the DOE of this embodiment is applied, restrains an increase of the less influential unnecessary light of the and grating down to the non-influential level, and remarkably decreases the influential unnecessary light of the mu grating. As a result, a quantity of unnecessary light that would otherwise reach the imaging plane is reduced and the deterioration of the imaging performance can be restrained. At the same time, the reduction of the diffraction efficiency of the designed order can be restrained to the non-influential level to the imaging performance.

Thus, the thin film 20 in the optical system to which the DOE 1 according to this embodiment is applied reduces unnecessary light that would otherwise reach the imaging plane, prevents the deterioration of the imaging performance, and restrains the diffraction efficiency of the designed order down to the non-influential level on the imaging performance.

Here, the grating pitch is set to 100 μm. Since a contribution of a wall surface lessens in an annulus having a wide grating pitch, the diffraction efficiency of the designed order improves and the diffraction efficiency of the unnecessary light becomes lower. In addition, although not illustrated, the propagation direction of the unnecessary light does not depend upon the grating pitch, and the propagation direction is the same. Therefore, the diffraction efficiency for the grating pitch of 100 μm is illustrated as one reference.

Now it is supposed that an incident angle of each of the off-screen light fluxes Bu, Bd is off-screen +10° and the incident angle ω is +13.16° to the optical axis direction. The influence of the unnecessary light of the DOE is comparatively inconspicuous at an angle smaller than this incident angle because there are increasing ghosts generated on the lens surface and caused by reflections on the imaging plane and scatters inside of the lens and caused by micro roughness on the surface. In addition, the influence of the unnecessary light of the DOE is comparatively small at an angle larger than this incident angle due to reflections on a front lens surface and light shielding by the lens barrel. Hence, the off-screen incident light flux near an incident angle of +10° is most influential on the unnecessary light of the DOE and thus the incident angle of +10° is presumed for the off-screen incident light flux.

This embodiment adheres two diffraction gratings closely to each other, properly sets a material and height of each diffraction grating, and realizes high diffraction efficiency in a wide wavelength range for a predetermined order of diffracted light.

In addition, the DOE 1 according to this embodiment can reduce unnecessary light that would otherwise reach the imaging plane by satisfying the following conditional expression, where nd1 is a refractive index of a material of the diffraction grating 11 to the d-line, nd2 is a refractive index of a material of the diffraction grating 12 to the d-line, and nd3 is a (minimum) refractive index of a material of one layer in the thin film 20 to the d-line.

The two relationships are established when the refractive index of the material of the diffraction grating 12 to the d-line is larger than the refractive index of the material of the diffraction grating 11 to the d-line. However, in case of nd1>nd2, an orientation of the grating shape of the diffraction grating becomes inverted and the influence of the unnecessary light by the grating wall surface behaves similarly. Therefore, the relationship can be generalized as follows:

In other words, the first relational expression means that a value made by subtracting the minimum refractive index of the material of one layer in the thin film 20 to the d-line from a larger one of the refractive indexes of the materials of the diffraction gratings 11, 12 is larger than 0.15 and smaller than 0.80. Since this embodiment sets the refractive indexes nd3=1.38, nd2=1.567, and nd1=1.504, nd2-nd3=0.187 and Expressions 1 are satisfied.

In addition, the next relational expression means that a thickness of the thin film 20 in the direction perpendicular to the stacking surface is larger than a value made by dividing 1 by a first value times 100 and smaller than 0.05×P, where P is a grating pitch. This embodiment satisfies this conditional expression because w is 0.2 μm and 1/{100×(nd2-nd3)}=0.053.

nd1<nd2

0.15<nd2-nd3<0.80

1/{100×(nd2-nd3)}<w<0.05×P Expression 1

In this embodiment, as illustrated in FIG. 6, the stop 40 shields a peak of the unnecessary light but another member may shield the unnecessary light.

### Second Embodiment

A second embodiment is similar to the first embodiment but is different from the first embodiment in that a width w of the thin film is 0.6 μm rather than 0.2 μm.

FIG. 14 is a graph of an RCWA calculation result with an incident angle of +10°, a grating pitch of 100 μm, and a wavelength of 550 nm by supposing the incident light flux “b” illustrated in FIG. 4 and the incident light flux “Bu” illustrated in FIG. 6.

The +1^{st} order diffracted light as the designed order provides the highest diffraction efficiency, but this +1^{st} order diffracted light never reaches the image plane and its influence is small. Similar to the first embodiment, the remaining unnecessary light becomes unnecessary light having a peak in the specific angle direction and propagates.

The peak angle of the unnecessary light in the −10° direction is almost the same as that in FIG. 8B, the spread of the unnecessary light is different between FIG. 14 and FIG. 8B. The diffraction efficiency at the low diffracted angle of FIG. 14 is lower. In other words, a quantity of unnecessary light at the low diffracted angle (the light fluxes “b2” in FIG. 13) is reduced in this embodiment.

In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order having the designed incident angle is propagated. From the RCWA calculation result, the diffraction efficiency near the diffracted angle of +0.20° in FIG. 14 is 0.0075% for the diffraction order of a −46^{th} order, and 0.0074% for the diffraction order of a −47^{th} order.

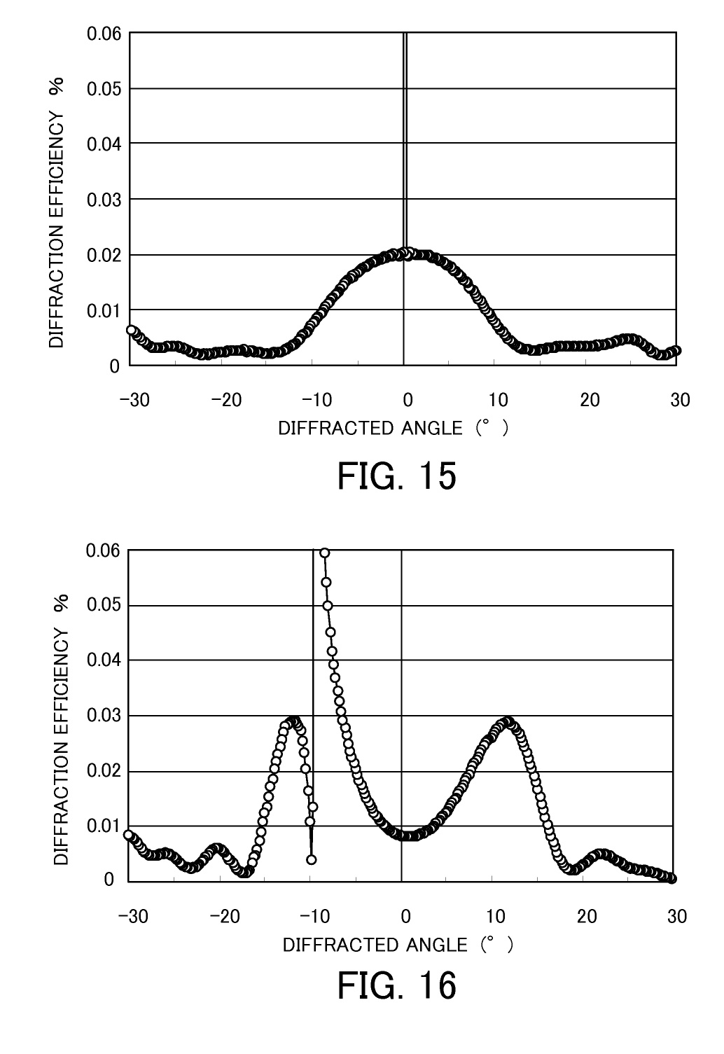

FIG. 15 is a graph of an RCWA calculation result with an incident angle of 0°, a grating pitch of 100 μm, and a wavelength of 550 nm by supposing the incident light flux “a” illustrated in FIG. 4.

The diffraction efficiency of the +1^{st} order diffracted light as the designed order is 97.70% and lower than that of the diffraction grating that has no low refractive index thin film. It is understood that the remaining light becomes unnecessary light, and propagates similar to the first embodiment. In addition, the low refractive index thin film is thicker than that in the first embodiment, and thus a reduced amount of the diffraction efficiency of the +1^{st} order diffracted light is larger than that of the first embodiment.

When the overall DOE region is considered, a difference of the diffraction efficiency of 1.06% with this grating pitch of 100 μm is seldom influential or problematic because it is rare to directly capture a high brightness light source, such as the sun, in daylight at the designed incident angle (the incident angle of the image pickup light). The influence of the unnecessary light is also small.

FIG. 16 is a graph of an RCWA calculation result with an incident angle of −10°, a grating pitch of 100 μm, and a wavelength of 550 nm by supposing the incident light flux “c” illustrated in FIG. 4.

As illustrated in FIG. 16, the +1^{st} order diffracted light as the designed order provides the highest diffraction efficiency, but this +1^{st} order diffracted light never reaches the image plane and its influence is small. Similar to the first embodiment, it is understood that the remaining unnecessary light becomes unnecessary light having a peak in the specific angle direction and propagates. As illustrated in FIGS. 2, 5, and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 16 is 0.0083% for the diffracted order of a +49^{th} order, and 0.0084% for the diffraction efficiency of the diffracted order of a +48^{th} order. Although this embodiment has higher diffraction efficiencies than the diffraction grating that has no low refractive index thin film, the values of the diffraction efficiency are extremely small and less influential on the deterioration of the imaging performance.

Thus, this embodiment provides a low refractive index thin film to the optical system to which the DOE of this embodiment is applied, restrains an increase of the less influential unnecessary light of the and grating to the non-influential level, and remarkably decreases the influential unnecessary light of the mu grating. As a result, a quantity of unnecessary light that would otherwise reach the imaging plane is reduced and the deterioration of the imaging performance can be restrained. At the same time, the deterioration of the diffraction efficiency of the designed order can be restrained to the non-influential level on the imaging performance.

Since 0.15<nd2-nd3=0.187<0.80 and 1/{100×(nd2-nd3)}=0.053 μm<w=0.6 μm<0.05×P=5.0 μm, this embodiment satisfies Expressions 1.

According to this embodiment, the thickness of the thin film 20 is not limited. Nevertheless, as its width becomes thicker, a phase shift region expands between the diffraction gratings 11 and 12, the diffraction efficiency of the unnecessary diffracted light of a comparatively low order increases, and the diffraction efficiency of the designed order (imaging performance) lowers.

Hence, the total thickness (width) w of the thin film may be less than the grating pitch of the DOE times 0.05 as in the following conditional expression where P is a grating pitch, w is a total thickness in the direction perpendicular to the stacking surface of the thin film 20 (when the thin film includes multiple layers, it is a total thickness of each layer):

0<W<0.05×P Expression 2

For the diffraction efficiency of the designed order, the width w of the thin film and the grating pitch P have a linear relationship, and the diffraction efficiency of the designed order of the diffraction grating having the grating pitch P and the width w of the thin film 20 is approximately equal to that of the diffraction grating having the grating pitch P×2 and the width w×2 of the thin film 20.

For example, the diffraction efficiency of the designed order of the diffraction grating in the first embodiment having the grating pitch 100 μm and a total width of the thin film of 1.0 μm is approximately equal to that of the diffraction grating having a grating pitch 200 μm and a total width of the thin film of 2.0 μm. Therefore, Expression 2 is established.

### Third Embodiment

A third embodiment is different from the first embodiment in that the thin film 20 is a gap (air: n=1.0) and other than that, the third embodiment is similar to the first embodiment.

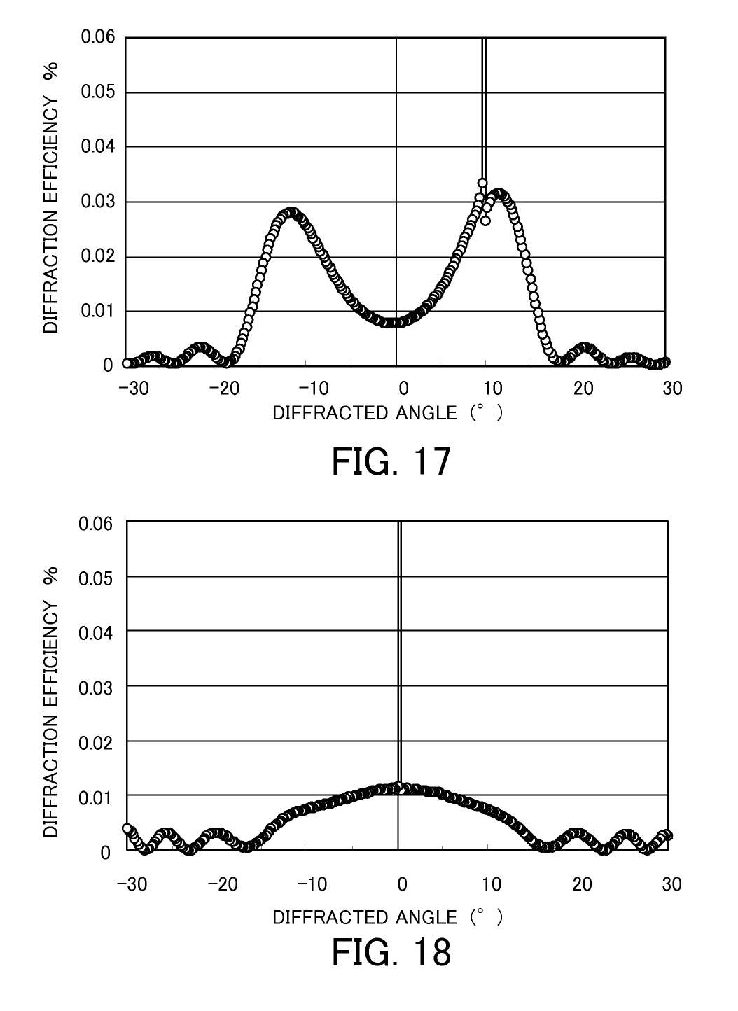

FIG. 17 is a graph of an RCWA calculation result with an incident angle of +10°, a grating pitch of 100 μm, and a wavelength of 550 nm by supposing the incident light flux “b” illustrated in FIG. 4 and the incident light flux “Bu” illustrated in FIG. 6.

The +1^{st} order diffracted light as the designed order provides the highest diffraction efficiency, but this +1^{st} order diffracted light never reaches the image plane and its influence is small. Similar to the first embodiment, it is understood that the remaining unnecessary light becomes unnecessary light having a peak in the specific angle direction and propagates.

The peak angle of the unnecessary light in the −10° direction is approximately the same as that of FIG. 8B, but a spread of the unnecessary light is different between FIG. 17 and FIG. 8B and FIG. 17 illustrates lower diffraction efficiency at a low diffracted angle. In other words, a quantity of unnecessary light at the low diffracted angle (the light fluxes “b2” in FIG. 13) is reduced according to this embodiment.

In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 17 is 0.0079% for the diffracted order of a −46^{th} order, and 0.0079% for the diffracted order of a −47^{th} order. Thus, similar to FIG. 7B, the diffraction efficiency is remarkably reduced.

FIG. 18 is a graph of an RCWA calculation result with an incident angle of 0°, a grating pitch of 100 μm, and a wavelength of 550 nm by supposing the incident light flux “a” illustrated in FIG. 4.

The diffraction efficiency of the +1^{st} order diffracted light as the designed order is 98.53% and lower than that of the diffraction grating that has no low refractive index thin film. The remaining light becomes unnecessary light, and propagates similar to the first and second embodiments.

When the overall DOE region is considered, a reduced amount of the diffraction efficiency by 0.23% with this grating pitch of 100 μm is seldom influential or problematic because it is rare to directly capture a high brightness light source, such as the sun, in daylight at the designed incident angle (the incident angle of the image pickup light). The influence of the unnecessary light is also small.

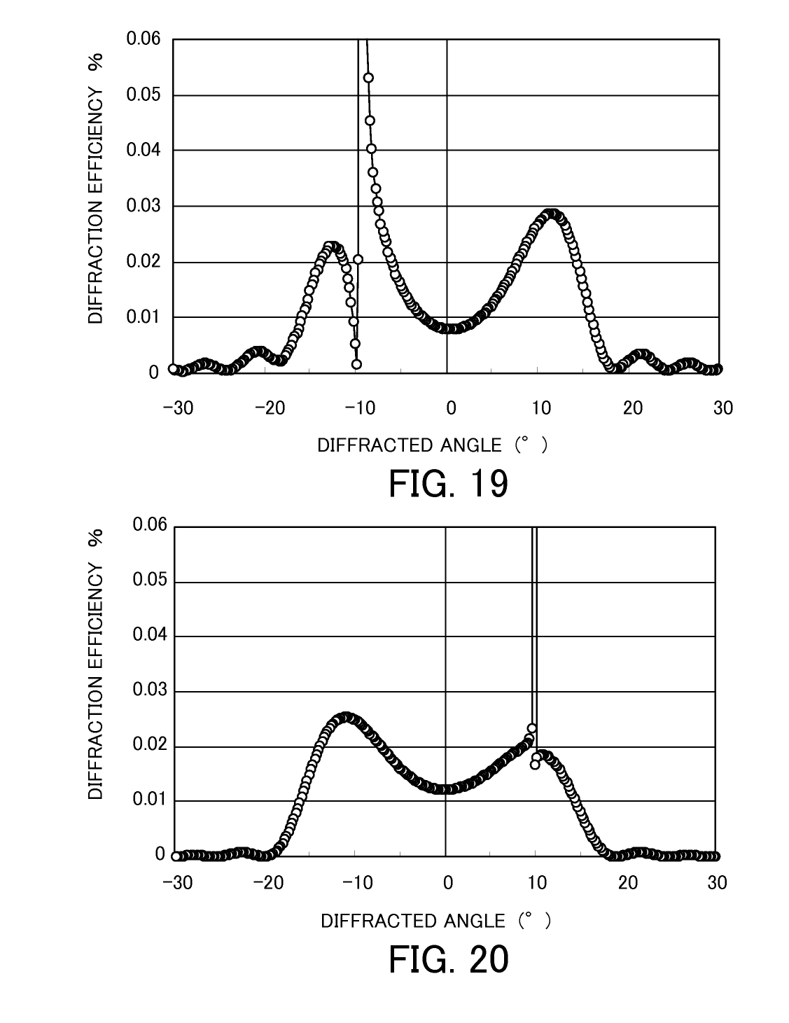

FIG. 19 is a graph of an RCWA calculation result with an incident angle of −10°, a grating pitch of 100 μm, and a wavelength of 550 nm by supposing the incident light flux “c” illustrated in FIG. 4.

As illustrated in FIG. 19, the +1^{st} order diffracted light as the designed order provides the highest diffraction efficiency, but this +1st order diffracted light never reaches the image plane and its influence is small. Similar to the first and second embodiments, it is understood that the remaining unnecessary light becomes unnecessary light having a peak in the specific angle direction and propagates. As illustrated in FIGS. 2, 5, and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 19 is 0.0079% for the diffracted order of a +49^{th} order, and 0.0079% for the diffracted order of a +48^{th} order. Although this embodiment has higher diffraction efficiencies than the diffraction grating that has no low refractive index thin film, the values of the diffraction efficiency are extremely small and less influential on the deterioration of the imaging performance.

Thus, this embodiment provides a low refractive index thin film to the optical system to which the DOE of this embodiment is applied, restrains an increase of the less influential unnecessary light of the and grating to the non-influential level, and remarkably decreases the influential unnecessary light of the mu grating. As a result, a quantity of unnecessary light that would otherwise reach the imaging plane is reduced and the deterioration of the imaging performance can be restrained. At the same time, the reduction of the diffraction efficiency of the designed order can be restrained to the non-influential level on the imaging performance.

Since 0.15<nd2-nd3=0.567<0.80 and 1/{100×(nd2-nd3)}=0.018 μm<w=0.2 μm<0.05×P=5.0 μm, this embodiment satisfies Expressions 1.

Thus, the thin film 20 in the optical system of this embodiment can reduce the unnecessary light that would otherwise reach the imaging plane, prevent the drop of the image performance, and restrain the diffraction efficiency of the designed order down to the non-influential level on the imaging performance.

### Comparative Example 2

A comparative example 2 is different from the first embodiment in that the thin film 20 is made of SiO₂ (n=1.47) and other than that, the third embodiment is similar to the first embodiment.

FIG. 20 is a graph of an RCWA calculation result with an incident angle of +10°, a grating pitch of 100 μm, and a wavelength of 550 nm by supposing the incident light flux “b” illustrated in FIG. 4 and the incident light flux “Bu” illustrated in FIG. 6.

The +1^{st} order diffracted light as the designed order provides the highest diffraction efficiency, but this +1^{st} order diffracted light never reaches the image plane and its influence is small. As illustrated in FIG. 20, the remaining unnecessary light becomes unnecessary light having a peak in the specific angle direction and propagates.

The peak angle of the unnecessary light in the −10° direction is approximately the same as that of FIG. 8B, and it is understood that the unnecessary light reducing effect is very limited. In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 20 is 0.012% for the diffracted order of a −46^{th} order, and 0.012% for the diffracted order of a −47^{th} order. Thus, the diffraction efficiency reducing effect is inconspicuous.

Since nd2-nd3=0.107, the comparative example 2 does not satisfy 0.15<nd2-nd3 in Expressions 1.

### Comparative Example 3

A comparative example 3 is different from the first embodiment in that a thickness of the thin film 20 is 0.05 μm rather than 0.2 μm and other than that, the third embodiment is similar to the first embodiment.

FIG. 21 is a graph of an RCWA calculation result with an incident angle of +10°, a grating pitch of 100 μm, and a wavelength of 550 nm by supposing the incident light flux “b” illustrated in FIG. 4 and the incident light flux “Bu” illustrated in FIG. 6.

The +1^{st} order diffracted light as the designed order provides the highest diffraction efficiency, but this +1^{st} order diffracted light never reaches the image plane and its influence is small. As illustrated in FIG. 21, the remaining unnecessary light becomes unnecessary light having a peak in the specific angle direction and propagates.

The peak angle of the unnecessary light in the −10° direction is approximately the same as that of FIG. 8B, and it is understood that the unnecessary light reducing effect is very limited. In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 21 is 0.012% for the diffracted order of a −46^{th} order, and 0.012% for the diffracted order of a −47^{th} order. Thus, the diffraction efficiency reducing effect is inconspicuous.

Since w=0.05 μm and 1/{100×(nd2-nd3)}=0.053, the comparative example 3 does not satisfy 1/{100×(nd2-nd3)}μm<w<0.05×P in Expressions 1.

From the results of the first to third embodiments and the comparative examples 1 to 3, it is understood that the influential unnecessary light of the mu grating can be remarkably reduced when Expressions 1 are satisfied.

In addition, as in the following example, a smaller one of the refractive indexes of the materials of the diffraction gratings 11, 12 to the d-line may be larger than a minimum refractive index of the material of one layer in the thin film 20 to the d-line, where nd2>nd1 is assumed. When Expression 3 is satisfied, he materials of the first and second gratings and the low refractive index thin film can be flexibly selected for the high diffraction efficiency and the unnecessary light reducing effect in the overall visible range:

nd1>nd3 Expression 3

### Fourth Embodiment

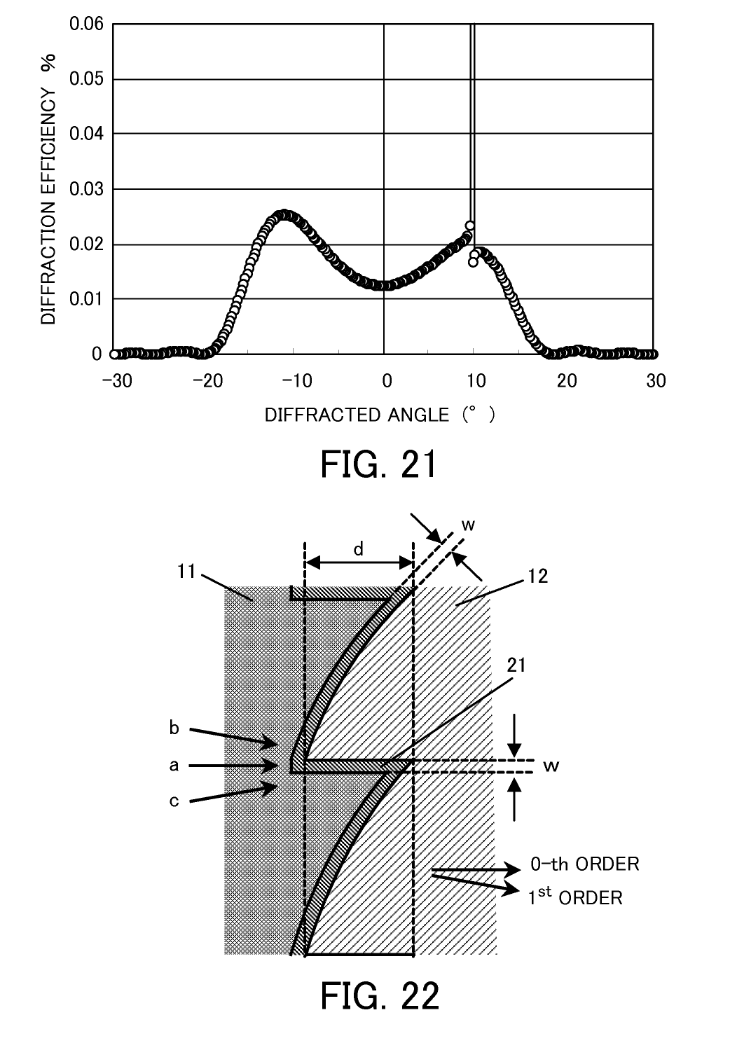

A fourth embodiment is different from the first embodiment in that a thin film is provided onto the overall interface rather than only onto a grating wall surface and other than that, the fourth embodiment is similar to the first embodiment. FIG. 22 is an enlarged sectional view of a diffraction grating of the fourth embodiment. For better understanding, FIG. 22 is exaggeratedly deformed in the grating periodic direction.

An MgF₂ thin film 21 is provided on the overall interface between the diffraction gratings 11 and 12, and the thin film 21 has an approximately uniform thickness (which is 0.2 μm similar to the first embodiment) over the overall region of the grating wall surface from the grating surface. For (an incident light flux “a” having) an incident angle of 0° as the designed incident angle on the grating surface of the DOE, it is designed so that the transmittance of the overall visible range (430 nm to 670 nm) can be 99% or higher. The thin film 21 is configured to provide an antireflection function to a perpendicularly (on-screen) incident light flux incident upon the grating surface, and to reduce a quantity of unnecessary light generated by an obliquely (off-screen) incident light flux which would otherwise reach the imaging plane. In this case, graphs of RCWA calculation results are similar to FIGS. 7A and 7B in the first embodiment with an incident angle of +10°, a grating pitch of 100 μm, and a wavelength of 550 nm by supposing the incident light “b” illustrated in FIG. 4 and the incident light “Bu” illustrated in FIG. 6. Therefore, similar to the first embodiment, the diffraction efficiency is more reduced than that of the comparative example 1.

Thus, the thin film 21 in the optical system according to this embodiment reduces unnecessary light that would otherwise reach the imaging plane, prevents the deterioration of the imaging performance, and restrains the diffraction efficiency of the designed order down to the non-influential level on the imaging performance. In addition, this embodiment provides a thin film on the overall interface, and thus can more easily and less expensively manufacture the DOE than the first to third embodiments. For example, a DOE manufacturing method may include, but is not limited to, forming a thin film onto an overall region from the grating surface to the grating wall surface by the vacuum evaporation etc. after the diffraction grating 12 is manufactured, and then forming the diffraction grating 11. The thin film provided on the overall interface can enhance the adhesion property between the diffraction gratings 11 and 12.

In the first to fourth embodiments and fifth and sixth embodiments, which will be described later, the diffraction gratings 11 and 12 satisfy the following conditional expressions, because if this relational expression is not satisfied, the selection freedom the material actually becomes narrower. Since this refractive index difference provides a transmittance of 99% or higher between the diffraction grating 11 and 12, it is usually unnecessary to provide an antireflection film on the interface. Nevertheless, the fourth to sixth embodiments provide the antireflection film and reduces the unnecessary light:

0<nd2-nd1<0.223 Expression 4

In this embodiment, nd2-nd1=0.063 is established, which corresponds to a reflectance difference of 1% or smaller between the diffraction gratings 11 and 12.

When a single-layer thin film is provided on the interface, the refractive indexes of the diffraction grating 12 and the low refractive index thin film satisfy the following expression. When this expression is not satisfied, the reflectance of the light having the designed incident angle increases:

nd2-nd3<0.223

In this embodiment, nd2-nd3=0.187 is satisfied, which corresponds to a reflectance difference of 1% or smaller between the diffraction grating and the low refractive index thin film.

This embodiment discusses a case where nd2 is larger than nd1, which is a refractive index of the material of the diffraction grating 11 to the d-line. However, in general, Expression 4 means that a value made by subtracting a smaller one of the refractive index of the material of the first diffraction grating to the d-line and the refractive index of the material of the second diffraction grating to the d-line from a larger one of them is larger than 0 and smaller than 0.223.

### Fifth Embodiment

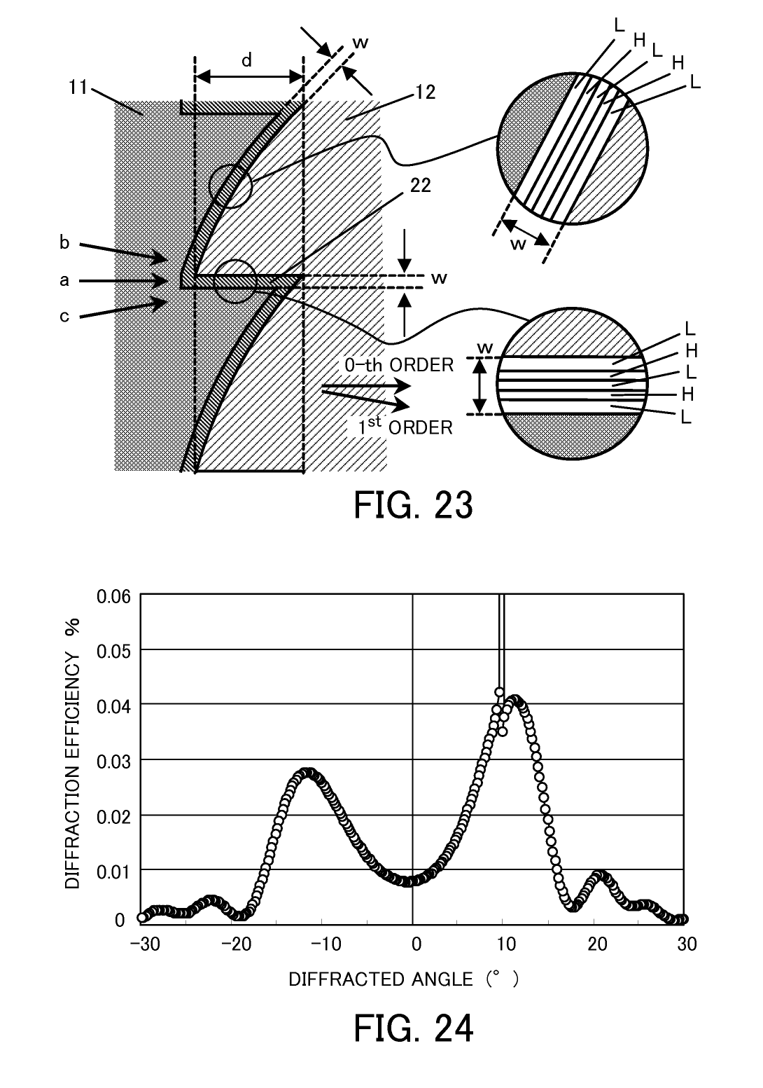

A fifth embodiment is different from the fourth embodiment in that a thin film 22 is not a single layer unlike the thin film 21 but is multilayered. FIG. 23 is an enlarged sectional view of a diffraction grating of the fifth embodiment. For better understanding, FIG. 23 is exaggeratedly deformed in the grating periodic direction.

The thin film 22 is provided on the overall interface between the diffraction gratings 11 and 12 (so that the thin film 22 is continuously provided from the grating wall surface to the grating surface), and the thin film 22 has an approximately uniform thickness over the overall region of the grating wall surface from the grating surface. The thin film 22 is configured to provide an antireflection function to a perpendicularly (on-screen) incident light flux incident upon the grating surface, and to reduce a quantity of unnecessary light generated by an obliquely (off-screen) incident light flux which would otherwise reach the imaging plane.

The thin film 21 is a multilayer film that includes 213L, 8H, 71L, 8H, and 215L in order from the diffraction grating 11 to the diffraction grating 12. Here, “H” denotes a high refractive index layer (TiO₂ layer (n=2.32)), “L” denotes a low refractive index layer (MgF₂ layer), and a numerical value denotes a physical film thickness (nm). In the five-layer thin film, one low refractive index thin film is designed physically thicker than another layer. For (an incident light flux “a” having) an incident angle of 0° as the designed incident angle on the grating surface of the DOE, it is designed so that the transmittance of the overall visible range (430 nm to 670 nm) can be 99.7% or higher. Due to the multilayer structure, the transmittance of the fifth embodiment is better than that of the fourth embodiment in the overall wavelength range.

FIG. 24 is a graph of an RCWA calculation result with an incident angle of +10°, a grating pitch of 100 μm, and a wavelength of 550 nm for the incident light flux “b” in FIG. 23 and the incident light flux “Bu” illustrated in FIG. 6.

The +1^{st} order diffracted light as the designed order provides the highest diffraction efficiency, but this +1^{st} order diffracted light never reaches the image plane and its influence is small. Similar to the first embodiment, it is understood that the remaining unnecessary light becomes unnecessary light having a peak in the specific angle direction and propagates.

The peak angle of the unnecessary light in the −10° direction is approximately the same as that of FIG. 8B, but a spread of the unnecessary light is different between FIG. 24 and FIG. 8B and FIG. 24 illustrates lower diffraction efficiency at a low diffracted angle. In other words, a quantity of unnecessary light at the low diffracted angle (the light fluxes “b2” in FIG. 13) is reduced according to this embodiment.

In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 24 is 0.0079% for the diffracted order of a −46^{th} order, and 0.0079% for the diffracted order of a −47^{th} order. Thus, similar to FIG. 7B, the diffraction efficiency is remarkably reduced.

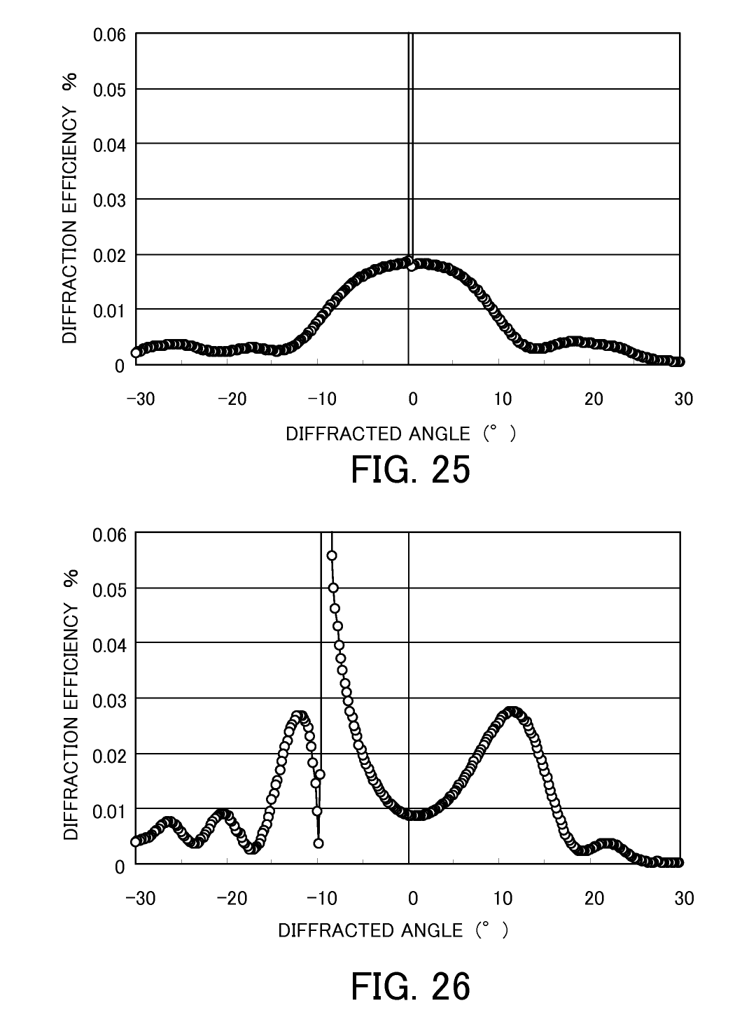

FIG. 25 is a graph of an RCWA calculation result with an incident angle of 0°, a grating pitch of 100 μm, and a wavelength of 550 nm by supposing the incident light flux “a” illustrated in FIG. 4.

The diffraction efficiency of the +1^{st} order diffracted light as the designed order is 97.87% and lower than that of the diffraction grating that has no multilayer film. The remaining light becomes unnecessary light, and propagates similar to the first embodiment.

When the overall DOE region is considered, a reduced amount of the diffraction efficiency by 0.89% with this grating pitch of 100 μm is seldom influential or problematic because it is rare to directly capture a high brightness light source, such as the sun, in daylight at the designed incident angle (the incident angle of the image pickup light). The influence of the unnecessary light is also small.

FIG. 26 is a graph of an RCWA calculation result with an incident angle of −10°, a grating pitch of 100 μm, and a wavelength of 550 nm by supposing the incident light flux “c” illustrated in FIG. 4.

As illustrated in FIG. 26, the +1^{st} order diffracted light as the designed order provides the highest diffraction efficiency, but this +1^{st} order diffracted light never reaches the image plane and its influence is small. Similar to the first embodiment, it is understood that the remaining unnecessary light becomes unnecessary light having a peak in the specific angle direction and propagates. As illustrated in FIGS. 2, 5, and 6, at least the diffracted light of the unnecessary light of the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 26 is 0.0079% for the diffracted order of a +49^{th} order, and 0.0079% for the diffracted order of a +48^{th} order. Although this embodiment has higher diffraction efficiencies than the diffraction grating that has no low refractive index thin film, the values of the diffraction efficiency are extremely small and less influential on the deterioration of the imaging performance.

Thus, this embodiment provides a low refractive index thin film to the optical system to which the DOE of this embodiment is applied, restrains an increase of the less influential unnecessary light of the and grating to the non-influential level, and remarkably decreases the influential unnecessary light of the mu grating. As a result, a quantity of unnecessary light that would otherwise reach the imaging plane is reduced and the deterioration of the imaging performance can be restrained. At the same time, the reduction of the diffraction efficiency of the designed order can be restrained to the non-influential level on the imaging performance.

Thus, the thin film 22 in the optical system according to this embodiment reduces unnecessary light that would otherwise reach the imaging plane, prevents the deterioration of the imaging performance, and restrains the diffraction efficiency of the designed order down to the non-influential level on the imaging performance.

The thin film 22 of this embodiment has a five-layer structure but the number of layers, the film thickness, and the film material are not limited, and a thin film having a single film structure may be adopted as illustrated in the first to fourth embodiments. When the film structure is designed, the antireflection characteristic on the grating surface and the unnecessary light restraining effect on the grating wall surface can be arbitrarily provided by selecting materials for the diffraction gratings 11 and 12. In the multilayer thin film, a layer made of a low refractive index material may be made optically thickest.

While the first to third embodiments provide a single-layer thin film on each grating wall surface, a multilayer thin film may be provided on the grating wall surface. Even in this case, in the multilayer thin film, the layer made of the low refractive index material may be made optically thickest.

### Sixth Embodiment

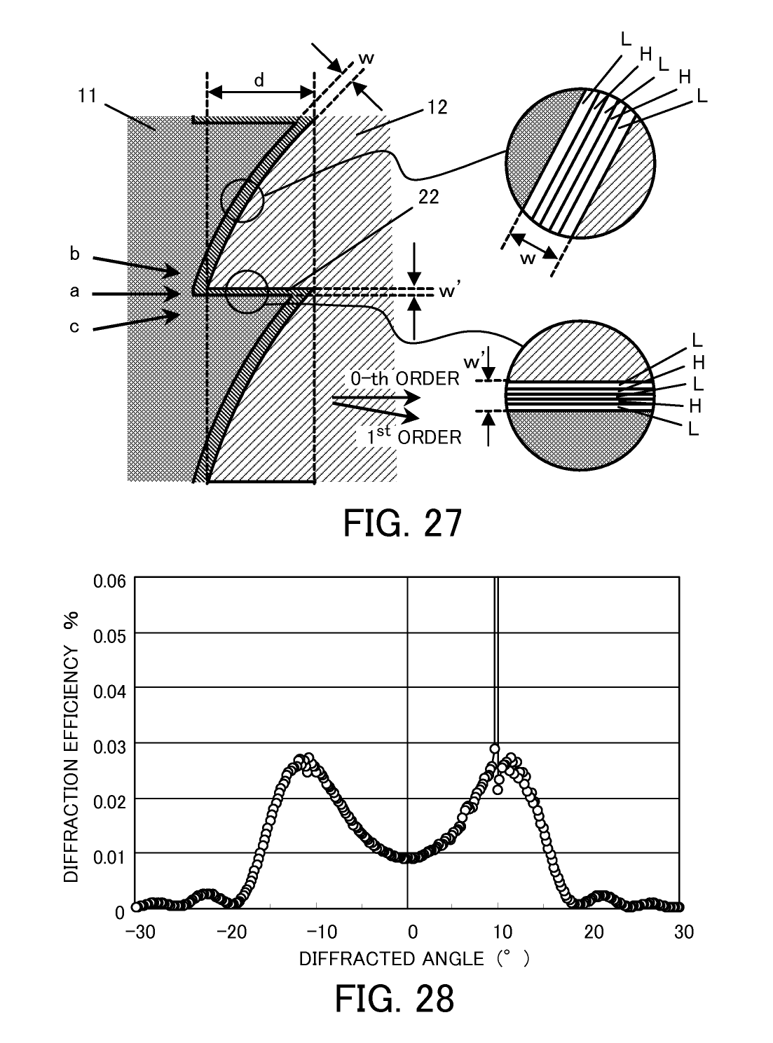

A sixth embodiment is similar to the fifth embodiment but different from the fifth embodiment in that a total thickness of the thin film on the grating surface differs from a total thickness of the thin film on the grating wall surface. In other words, the total thickness of the thin film differs according to a position on the interface. FIG. 27 is an enlarged sectional view of the diffraction grating according to the sixth embodiment. For better understanding, FIG. 27 is exaggeratedly deformed in the grating periodic direction.

The thin film 22 is a multilayer film that includes 213L, 8H, 71L, 8H, and 215L in order from the diffraction grating 11 to the diffraction grating 12. Here, “H” denotes a high refractive index layer (TiO₂ layer), “L” denotes a low refractive index layer (MgF₂ layer), and a numerical value denotes a physical film thickness (nm). In the five-layer thin film, one low refractive index thin film is designed physically thicker than another layer. A film thickness of the thin film 22 on the grating wall surface is set to half a physical thickness, and more specifically includes 107L, 4H, 35L, 4H, and 108L. In the five-layer thin film, one low refractive index thin film is designed physically thicker than another layer.

FIG. 28 is a graph of an RCWA calculation result with an incident angle of +10°, a grating pitch of 100 μm, and a wavelength of 550 nm for the incident light flux “b” in FIG. 27 and the incident light flux “Bu” illustrated in FIG. 6.

The +1^{st} order diffracted light as the designed order provides the highest diffraction efficiency, but this +1st order diffracted light never reaches the image plane and its influence is small. Similar to the first embodiment, it is understood that the remaining unnecessary light becomes unnecessary light having a peak in the specific angle direction and propagates.

The peak angle of the unnecessary light in the −10° direction is approximately the same as that of FIG. 8B, but a spread of the unnecessary light is different between FIG. 28 and FIG. 8B and FIG. 28 illustrates lower diffraction efficiency at a low diffracted angle. In other words, a quantity of unnecessary light at the low diffracted angle (the light fluxes “b2” in FIG. 13) is reduced according to this embodiment.

In the optical system illustrated in FIGS. 5 and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 28 is 0.0093% for the diffracted order of a −46^{th} order, and 0.0093% for the diffracted order of a −47^{th} order. Thus, similar to FIG. 7B, the diffraction efficiency is remarkably reduced.

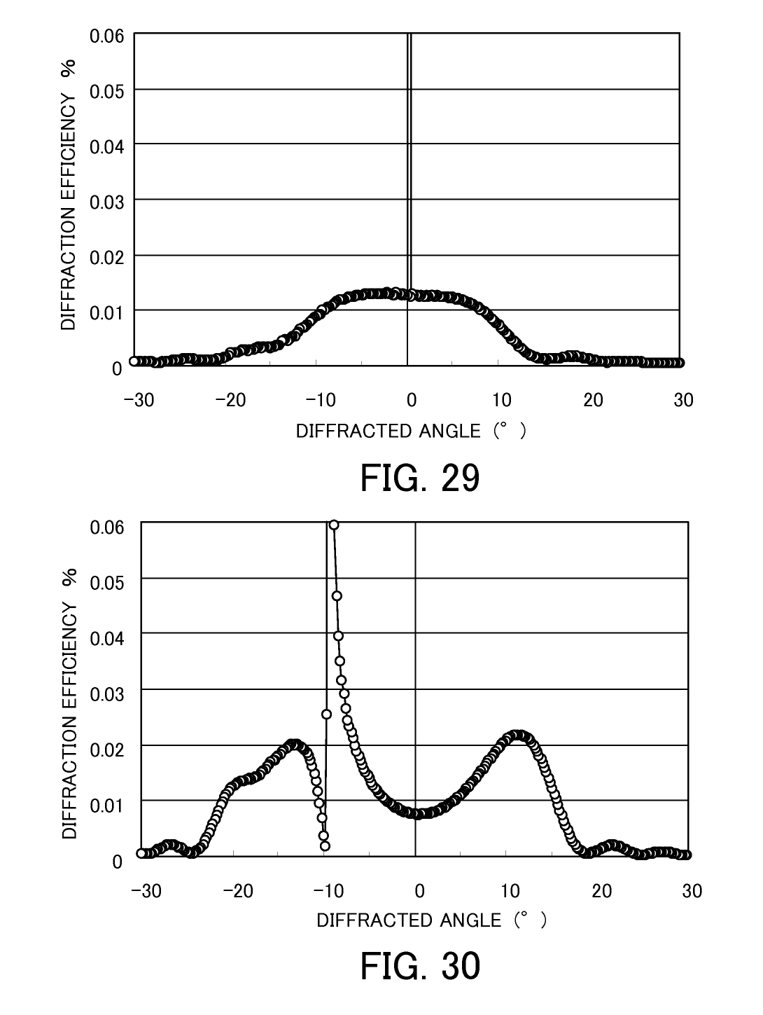

FIG. 29 is a graph of an RCWA calculation result with an incident angle of 0°, a grating pitch of 100 μm, and a wavelength of 550 nm by supposing the incident light flux “a” illustrated in FIG. 4.

The diffraction efficiency of the +1^{st} order diffracted light as the designed order is 98.42% and lower than that of the diffraction grating that has no multilayer film. The remaining light becomes unnecessary light, and propagates similar to the first embodiment.

When the overall DOE region is considered, a reduced amount of the diffraction efficiency by 0.89% with this grating pitch of 100 μm is seldom influential or problematic because it is rare to directly capture a high brightness light source, such as the sun, in daylight at the designed incident angle (the incident angle of the image pickup light). The influence of the unnecessary light is also small.

FIG. 30 is a graph of an RCWA calculation result with an incident angle of −10°, a grating pitch of 100 μm, and a wavelength of 550 nm by supposing the incident light flux “c” illustrated in FIG. 4.

As illustrated in FIG. 30, the +1^{st} order diffracted light as the designed order provides the highest diffraction efficiency, but this +1^{st} order diffracted light never reaches the image plane and its influence is small. Similar to the first embodiment, it is understood that the remaining unnecessary light becomes unnecessary light having a peak in the specific angle direction and propagates. As illustrated in FIGS. 2, 5, and 6, at least the diffracted light of the unnecessary light derived from the off-screen light reaches the image plane, when the diffracted light has a diffracted angle approximately equal to the diffracted angle of +0.20° at which the designed diffracted order at the designed incident angle is propagated. From the RCWA calculation result, the diffraction efficiency near the diffracted angle of +0.20° in FIG. 30 is 0.0076% for the diffracted order of a +49^{th} order, and 0.0076% for the diffracted order of a +48^{th} order. Although this embodiment has higher diffraction efficiencies than the diffraction grating that has no low refractive index thin film, the values of the diffraction efficiency are extremely small and less influential on the deterioration of the imaging performance.

Thus, this embodiment provides a low refractive index thin film to the optical system to which the DOE of this embodiment is applied, restrains an increase of the less influential unnecessary light of the and grating to the non-influential level, and remarkably decreases the influential unnecessary light of the mu grating. As a result, a quantity of unnecessary light that reaches the imaging plane reduces and the deterioration of the imaging performance can be restrained. At the same time, the reduction of the diffraction efficiency of the designed order can be restrained to the non-influential level on the imaging performance.

Thus, the thin film 22 in the optical system according to this embodiment reduces unnecessary light that would otherwise reach the imaging plane, prevents the deterioration of the imaging performance, and restrains the diffraction efficiency of the designed order down to the non-influential level on the imaging performance.

As in this embodiment, the thickness of the film thickness on the grating surface may be different from that on the grating wall surface. This embodiment can more easily and less expensively manufacture the DOE. In an example, when the thin film is formed by the vacuum evaporation, a film thickness on the serrated grating surface is generally different from a film thickness on the grating wall surface in the

Blazed grating, and moreover the film thickness is also different when the diffraction grating is produced on a lens surface as illustrated in FIG. 3. Therefore, by arbitrarily designing the antireflection function of the grating surface and the flare reducing function of the grating wall surface in accordance with the manufacturing method, a reduction of the diffraction efficiency of the designed order and a reduction of the unnecessary light caused by the off-screen light flux can be compromised.

Table 1 summarizes the results of the first to sixth embodiments. The diffraction efficiency (%) in the table is obtained by the RCWA calculation result with an incident angle of +10°, a grating pitch of 100 μm for the diffracted order of the −46^{th} order and the diffracted order of the −47^{th} order corresponding to the incident light flux “Bu.” Table 1 indicates a film thickness on the grating surface for the sixth embodiment:

TABLE 1

| | FIRST | SECOND | THIRD | FOURTH | FIFTH | SIXTH |
|---|---|---|---|---|---|---|
| | EMBOD. | EMBOD. | EMBOD. | EMBOD. | EMBOD. | EMBOD. |
| nd1 | 1.504 | | | | | |
| nd2 | 1.567 | | | | | |
| nd3 | 1.38 | 1.38 | 1 | 1.38 | 1.38 | 1.38 |
| nd2 − nd3 | 0.187 | 0.187 | 0.567 | 0.187 | 0.187 | 0.187 |
| TOTAL | 0.2 | 0.6 | 0.2 | 0.2 | 0.213 (L) | 0.107 (L) |
| THICKNESS | | | | | 0.008 (H) | 0.004 (H) |
| w3 (μm) OF | | | | | 0.071 (L) | 0.035 (L) |
| THIN FILM | | | | | 0.008 (H) | 0.004 (H) |
| | | | | | 0.215 (L) | 0.108 (L) |
| 1/{100 · | 0.053 | 0.053 | 0.018 | 0.053 | 0.053 | 0.053 |
| (nd2 − nd3)} | | | | | | |
| μm | | | | | | |
| DIFFRACTION | | | | | | |
| EFFICIENCY | | | | | | |
| (%) | | | | | | |
| DIFFRACTED | 0.0092 | 0.0075 | 0.0079 | 0.0092 | 0.0079 | 0.0093 |
| ORDER: - | | | | | | |
| 46^{TH} ORDER | | | | | | |
| DIFFRACTED | 0.0092 | 0.0074 | 0.0079 | 0.0092 | 0.0079 | 0.0093 |
| ORDER: - | | | | | | |
| 47^{TH} ORDER | | | | | | |

Table 2 summarizes Comparative Examples 1 to 3:

TABLE 2

| | COMPARA- | | |
|---|---|---|---|
| | TIVE | COMPARATIVE | COMPARATIVE |
| | EXAMPLE 1 | EXAMPLE 2 | EXAMPLE 3 |
| nd1 | 1.504 | | |
| nd2 | 1.567 | | |
| nd3 | — | 1.46 | 1.38 |
| nd2 − nd3 | — | 0.107 | 0.187 |
| TOTAL | 0 | 0.2 | 0.05 |
| THICKNESS | | | |
| w3 (μm) OF | | | |
| THIN FILM | | | |
| 1/{100 · (nd2 − | — | 0.093 | 0.053 |
| nd3)} μm | | | |
| DIFFRACTION | | | |
| EFFICIENCY | | | |
| (%) | | | |
| DIFFRACTED | 0.014 | 0.012 | 0.012 |
| ORDER: - | | | |
| 46^{TH} ORDER | | | |
| DIFFRACTED | 0.014 | 0.012 | 0.012 |
| ORDER: - | | | |
| 47^{TH} ORDER | | | |

It is not always necessary to provide a thin film onto all annuluses or the thin film may be provided only onto part of the annulus. In this case, it is effective to provide a thin film to part including a minimum grating pitch. This is because a diffraction grating having a smaller grating pitch has larger diffraction efficiency of unnecessary light and thus the contribution of the unnecessary light that is generated by the entire DOE is large.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-134018, filed Jun. 11, 2010, which is hereby incorporated by reference herein in its entirety.

What is claimed is:

1. A diffractive optical element comprising:
a first diffraction grating and a second diffraction grating which are made of materials different from each other and are stacked in an optical axis direction; and
a thin film which is arranged at least part of an interface between the first diffraction grating and the second diffraction grating, includes a single layer or multiple layers made of a material different from that of each of the first and second diffraction gratings, and is transparent to light of a working wavelength range,
wherein the following conditional expressions are satisfied,
nd1<nd2
0.15<nd2-nd3<0.80
1/{100×(nd2-nd3)}<w<0.05×P Expression 1
where nd1 is a refractive index of the material of the first diffraction grating to d-line, nd2 is a refractive index of the material of the second diffraction grating to the d-line, nd3 is a minimum refractive index of the material of one layer of the thin film to the d-line, w is a total thickness, and P is a grating pitch.

2. The diffractive optical element according to claim 1, wherein the refractive indexes of the materials of the first and second diffraction gratings satisfy the following conditional expression:
0<nd2-nd1<0.223

3. The diffractive optical element according to claim 1, wherein the thin film is arranged only on a grating wall surface.

4. The diffractive optical element according to claim 1, wherein the thin film includes multiple layers each having a different refractive index, and a layer having a low refractive index is physically thicker than a layer having a high refractive index in the multiple layers.

5. The diffractive optical element according to claim 1, wherein a thickness of the thin film differs according to a position on the interface.

6. The diffractive optical element according to claim 1, wherein the thin film is continuously provided from a grating wall surface to a grating surface.

7. The diffractive optical element according to claim 6, wherein the thin film satisfies the following expression:
nd2-nd3<0.223

8. An optical system comprising:
a diffractive optical element according to claim 1; and
a stop arranged at a rear side of the diffractive optical element.

9. An optical apparatus including the optical system according to claim 8.
